(19) United States
(12) Patent Application Publication
(10) Pub. No.: US 2013/0297510 A1
(43) Pub. Date: Nov. 7, 2013

(54) FINANCIAL INTERMEDIARY FOR ELECTRONIC COMMERCE

(71) Applicant: IP ORIGINS, LLC, Davie, FL (US)

(72) Inventor: Chapman Ducote, Miami Beach, FL (US)

(73) Assignee: IP Origins, LLC, Davie, FL (US)

(21) Appl. No.: 13/888,087

(22) Filed: May 6, 2013

Related U.S. Application Data
(60) Provisional application No. 61/642,834, filed on May 4, 2012.

(51) Int. Cl. G06Q 20/02

(52) U.S. Cl. CPC G06Q 20/02
USPC 705/44

(57) ABSTRACT

Disclosed are various embodiments for an electronic escrow intermediary application that permits a buyer and seller to conduct a digital escrow transaction involving a third-party intermediary. An electronic transaction can occur through a third-party electronic commerce application or through the escrow intermediary application itself. Registration of a buyer and a seller is verified and either party is permitted to choose a registered third-party intermediary. After a purchase is made by a buyer, the terms and regulations associated with the transaction are transmitted to the third-party intermediary. The purchase money is placed in an escrow account until verification has been received by the third-party intermediary that the item has been delivered, complies with government regulations, and is, in fact, what the seller represents. Upon verification, the purchase money is distributed according to the terms of the transaction to the seller and to the third-party intermediary.

### CROSS REFERENCE TO RELATED APPLICATIONS

This application claims priority to U.S. Provisional patent application entitled “FINANCIAL INTERMEDIARY FOR ELECTRONIC COMMERCE,” filed on May 4, 2012, and assigned application No. 61/642,834, which is incorporated herein by reference in its entirety.

### BACKGROUND

There is a surge in websites conducting electronic commerce in a variety of industries. The typical online transaction in an electronic commerce application can require a buyer to make a purchase by providing sensitive financial information before an item is shipped or delivered to the buyer. In many cases, the purchase money is automatically deposited in the seller's account. A buyer is unable to inspect the item purchased and, in some cases, is unable to return it to the seller if the item is not what the buyer had expected. The seller may be able to retain the buyer's sensitive financial information. Additionally, regulations in particular sales of items, such as firearms or vehicles, create additional obstacles to a lawful transaction.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIGS. 2-8 are drawings of examples of user interfaces rendered by a client in the networked environment of FIG. 1 according to various embodiments of the present disclosure.

FIG. 9 is a flowchart illustrating one example of functionality implemented as portions of an escrow intermediary application executed in a computing device in the networked environment of FIG. 1 according to various embodiments of the present disclosure.

FIG. 10 is a schematic block diagram that provides one example illustration of a computing device employed in the networked environment of FIG. 1 according to various embodiments of the present disclosure.

### DETAILED DESCRIPTION

Disclosed herein are various embodiments relating to providing a way to permit buyers and sellers to conduct escrow transactions involving third-party intermediaries. When a buyer purchases a product through an electronic commerce website, a buyer is typically charged immediately upon the completion of the electronic checkout process. The purchase money is subsequently deposited into an account associated with the seller. A seller acting in good faith then ships or delivers the purchased item to the buyer. This scenario leaves the buyer in a state of uncertainty as to whether the purchased item will be delivered and/or delivered as described. A seller may also retain access to a buyer's sensitive financial information used in purchasing the product. Such sensitive information could include credit card numbers, names, addresses, telephone numbers, and other information about the buyer. Additionally, rules or regulations can be imposed by a government or an entity in transactions of certain items such as firearms, high-valued art and antiques, motor vehicles, real estate, boats, and many other items. Complying with regulations governing a particular transaction may place an additional burden on both the buyer and the seller.

For example, if the purchase money paid by a buyer in an electronic transaction were to be placed in a third-party escrow account, uncertainty associated with the electronic commerce transaction may be alleviated. It would ensure that the seller is not able to view and/or retain sensitive financial information associated with the buyer. Furthermore, it would ensure that payment will not be made to the seller unless the product is delivered as described. Finally, if a third-party intermediary were to authenticate and/or inspect the purchase item, as well as ensure compliance with government regulations, the anxiety associated with the transaction may be further reduced.

Various embodiments herein provide for an escrow intermediary application that permits a buyer and seller to conduct a digital escrow transaction involving a third-party intermediary, if desired. In the following discussion, a general description of the system and its components are provided, followed by a discussion of the operation of the same.

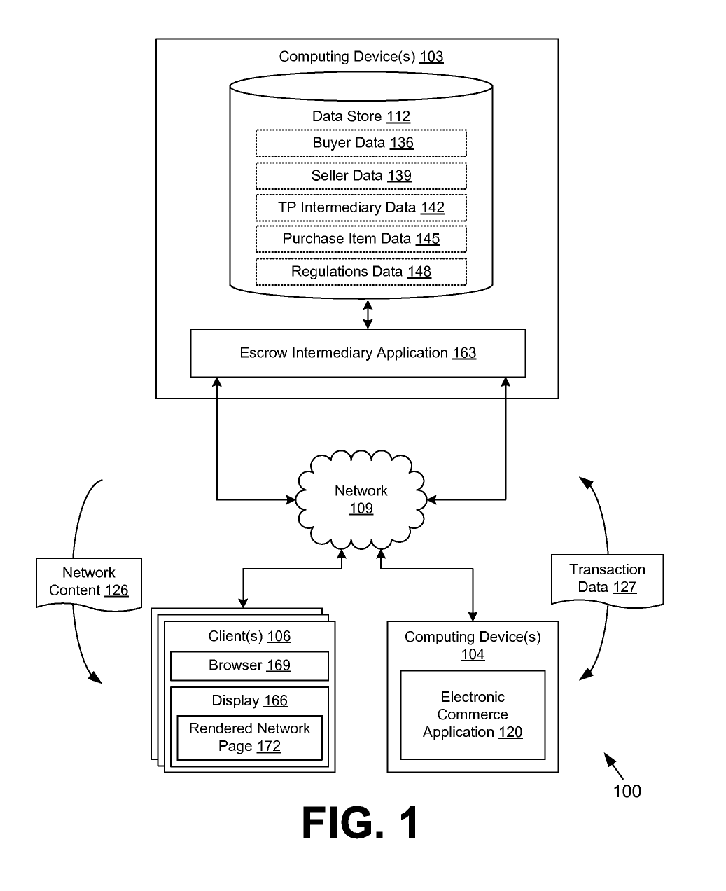

With reference to FIG. 1, shown is a networked environment 100 according to various embodiments. The networked environment 100 includes a computing device 103 in data communication with one or more clients 106 and one or more computing devices 104 via a network 109. The network 109 includes, for example, the Internet, intranets, extranets, wide area networks (WANs), local area networks (LANs), wired networks, wireless networks, or other suitable networks, etc., or any combination of two or more such networks.

The computing device 103 can comprise, for example, a server computer or any other system providing computing capability. Alternatively, a plurality of computing devices 103 can be employed that are arranged, for example, in one or more server banks or computer banks or other arrangements. For example, a plurality of computing devices 103 together can comprise a cloud computing resource, a grid computing resource, and/or any other distributed computing arrangement. Such computing devices 103 can be located in a single installation or can be distributed among many different geographical locations. For purposes of convenience, the computing device 103 is referred to herein in the singular. Even though the computing device is referred to in the singular, it is understood that a plurality of computing devices 103 can be employed in the various arrangements as described above.

Various applications and/or other functionalities can be executed in the computing device 103 according to various embodiments. Also, various data is stored in a data store 112 that is accessible to the computing device 103. The data store 112 can be representative of a plurality of data stores. The data stored in the data store 112 for example, is associated with the operation of the various applications and/or functional entities described below.

The components executed on the computing device 103 for example, are an escrow intermediary application 163, and other applications, services, processes, systems, engines, or functionality not discussed in detail herein. The escrow intermediary application 163 is executed to communicate with the electronic commerce application 120 to conduct the electronic transaction and to provide transaction data 127 via the network 109. For example, the escrow intermediary application 163 may take the buyer's financial information provided by the electronic commerce application 120, charge an account listed in the financial information, and place the equivalent amount in an escrow account. The escrow intermediary application would then provide transaction data 127 to the buyer and seller via the electronic commerce application 120 or through e-mail, instant messaging, SMS, facsimile, or any other form of electronic communication.

In one embodiment, the escrow intermediary application 163 verifies that the buyer and seller are registered in an electronic database prior to conducting an electronic transaction. If a buyer and/or seller are not registered, the escrow intermediary application would prompt the buyer and/or seller to register an account. Registration creates an electronic profile of the buyer/seller that can contain personal information, financial information, purchase/sales history, and any other information.

In one embodiment, the escrow intermediary application 163 facilitates the selection of a registered third-party intermediary, also referred to as a dealer, by providing the buyer and/or seller with a list of registered third-party intermediaries. In another embodiment, the third-party intermediary can be automatically selected by the escrow intermediary application 163. The selection can be based on proximity to a location specified by either the buyer or the seller or an account associated with the buyer or seller.

The escrow intermediary application 163 would associate the item being purchased as well as any terms provided by a buyer or seller with the electronic transaction. For example, a transaction can be assigned a unique transaction identification number. The transaction identification number, transaction terms, purchase item(s), quantity, price, and any other information associated with the transaction can be stored in an electronic database as a log of the transaction. The transaction terms can be, for example, the shipping address of the buyer, requirements and eligibility to participate in the electronic transaction, and any other terms relevant to the electronic transaction. In one embodiment, the transaction terms and/or the electronic profiles of the buyer and seller can only be provided by the escrow intermediary application 163 to the third-party intermediary in order to provide anonymity in the transaction. In this embodiment, the escrow intermediary application 163 will not authorize the buyer to obtain the identity of the seller and vice versa.

The escrow intermediary application 163 can automatically determine any regulations associated with the electronic transaction. For example, if the purchase item in the electronic transaction is a firearm, the escrow intermediary application can automatically determine national, state, and municipal laws and/or regulations determined by the seller and/or buyer's address. In one embodiment, laws and/or regulations are stored in and/or accessed from an electronic database as regulation data 148.

If a registered third-party intermediary is selected to assist with the transaction, the escrow intermediary application 163 can automatically send the terms and regulations associated with the electronic transaction to the third-party intermediary. The escrow intermediary application 163 can verify that the third-party intermediary has received shipment of the purchase item, verify that the purchase item is actually what was described by the seller, and verify compliance with the determined regulations, for example, by requiring the third-party intermediary to complete and sign an electronic form generated by the escrow intermediary application 163. Upon verification of the above and delivery of the purchase item to the buyer, the purchase money placed in escrow can be released or transferred to the seller and/or third-party intermediary as commission. The purchase money may be released by a buyer, a dealer acting as a third-party intermediary, an administrator of the escrow intermediary application 163, an administrator of the escrow account, and/or various other parties as anticipated herein. Finality of the transaction can be communicated as transaction data 127 to the electronic commerce application 120.

The data stored in the data store 112 includes, for example, buyer data 136, seller data 139, third-party intermediary data 142, purchase item data 145, regulation(s) data 148, and potentially other data. The purchase item data 145 can include information related to a plurality of items offered for sale in the electronic commerce application 120. An item can refer to a product, good, service, software download, multimedia download, social networking profile, or any combination, bundle, or package thereof, that can be offered for sale, purchase, rental, lease, download, and/or any other form of consumption as can be appreciated. The various data stored in purchase item data 145 can include, for example, titles, descriptions, quantities, conditions, images, options, weights, customer reviews, customer ratings, keywords, shipping restrictions, prices, tax classifications, unique identifiers, government regulations, and any other data related to the items.

The network content 126 includes data that can be used in the rendering of a network page 172. Such data can include templates, code, images, audio, video, hypertext markup language (HTML), extensible markup language (XML), JavaScript, cascading style sheets (CSS), and/or other data.

Referring back to FIG. 1, the computing device 104 can comprise, for example, a server computer or any other system providing computing capability. Alternatively, a plurality of computing devices 104 can be employed that are arranged, for example, in one or more server banks or computer banks or other arrangements. For example, a plurality of computing devices 104 together can comprise a cloud computing resource, a grid computing resource, and/or any other distributed computing arrangement. Such computing devices 104 can be located in a single installation or can be distributed among many different geographical locations. For purposes of convenience, the computing device 104 is referred to herein in the singular. Even though the computing device 104 is referred to in the singular, it is understood that a plurality of computing devices 104 can be employed in the various arrangements as described above.

Various applications and/or other functionalities can be executed in the computing device 104 according to various embodiments. The components executed on the computing device 104, for example, include an electronic commerce application 120, and other applications, services, processes, systems, engines, or functionalities not discussed in detail herein. The electronic commerce application 120 is executed in order to facilitate the online purchase of items from one or more electronic marketplaces over the network 109. The electronic commerce application 120 also performs various backend functions associated with the online presence of an electronic marketplace in order to facilitate the online purchase of items as will be described. For example, the electronic commerce application 120 generates network content 126 such as, for example, web pages and/or other types of network content that is provided to clients 106 for the purposes of promoting and selecting items for purchase, rental, download, lease, or any other forms of consumption. In one embodiment, the computing device 104 is operated by a different entity from the computing device 103.

The client 106 is representative of a plurality of client devices that can be coupled to the network 109. The client 106 can comprise, for example, a processor-based system such as a computer system. Such a computer system can be embodied in the form of a desktop computer, a laptop computer, a personal digital assistant, a cellular telephone, set-top box, music players, web pads, tablet computer systems, game consoles, or other devices with like capability. The client 106 can include a display 166. The display 166 can comprise, for example, one or more devices such as cathode ray tubes (CRTs), liquid crystal display (LCD) screens, gas plasma-based flat panel displays, LCD projectors, or other types of display devices, etc. The display can provide the rendered network page 172.

The client 106 can be configured to execute various applications such as a browser 169 and/or other applications. The browser 169 can be executed in a client 106 for example, to access and render network pages 172, such as web pages, or other network content served up by the computing device 103 and/or other servers. The client 106 can be configured to execute applications beyond browser 169 such as, for example, email applications, instant message applications, and/or other applications.

Next, a general description of the operation of the various components of the networked environment 100 is provided. To begin, an electronic commerce application 120 relays information pertaining to a digital transaction to the escrow intermediary application 163 via the network 109. The information can be, for example, information associated with an item being purchased on an electronic commerce application 120 such as an item identification number, a price, a quantity, a seller identification number, a buyer identification number, the buyer's financial information, and/or any other information related to the transaction. The escrow intermediary application 163 conducts a digital escrow transaction using the buyer's financial information. The terms of the transaction, provided by a buyer, the seller, or the electronic commerce application 120, are communicated to the buyer, the seller, and the third-party intermediary via the escrow intermediary application 163. The escrow intermediary application 163 then returns confirmation of payment and any other information to the electronic commerce application 120.

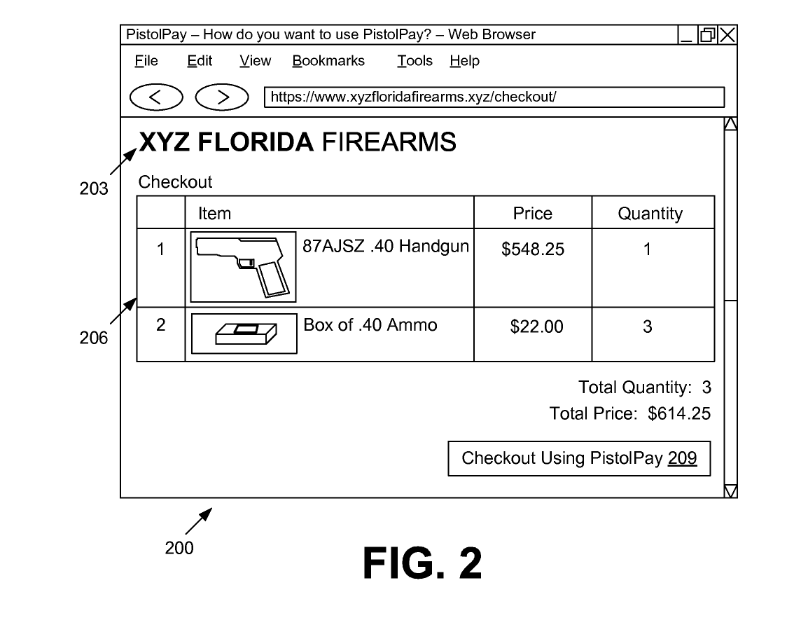

Referring next to FIG. 2, shown is an example of a user interface 200 rendered in the browser 169 (FIG. 1) executed in the client 106 (FIG. 1) in the networked environment 100 (FIG. 1) according to various embodiments. Specifically, the user interface 200 depicts a rendered network page 172 that corresponds to a checkout process of items in an electronic shopping cart in a third-party electronic commerce application 120. In this non-limiting example, the title 203 indicates that the electronic commerce application 120 corresponds to an independent third-party seller. A “Checkout Using PistolPay” button 209 indicates that the items and quantities in the electronic shopping cart 206 can be purchased via the PistolPay escrow intermediary application 163.

In one embodiment, the checkout process can occur in the third-party electronic commerce application 120 by communicating with the escrow intermediary application 163 via an application programming interface (API). The checkout can occur on the third-party domain without requiring the user to leave the domain to visit a separate payment domain. In another embodiment, the button 209 will take the user to an escrow intermediary application 163 on a domain separate from the third-party electronic commerce application 120. In both embodiments, the information associated with the items and quantities in the electronic shopping cart 206 are communicated by electronic commerce application 120 to the escrow intermediary application 163.

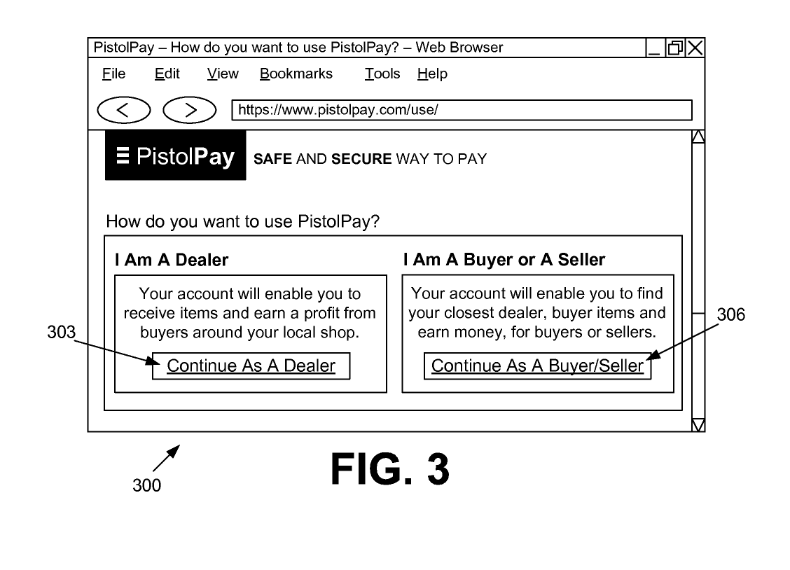

Turning now to FIG. 3, shown is a user interface 300 depicting a rendered network page 172 for one exemplary way in which the escrow intermediary application 163 can be used. In this example, the representative user interface 300 prompts the user to assume a role as a dealer via button 303 or as a buyer/seller via button 306. The role of the user can be helpful in tailoring the type of information later presented to the user. For example, a dealer can use the site to find transactions where the dealer has been requested as a third-party intermediary. A buyer/seller, on the other hand, can need to conduct transactions and/or locate a dealer.

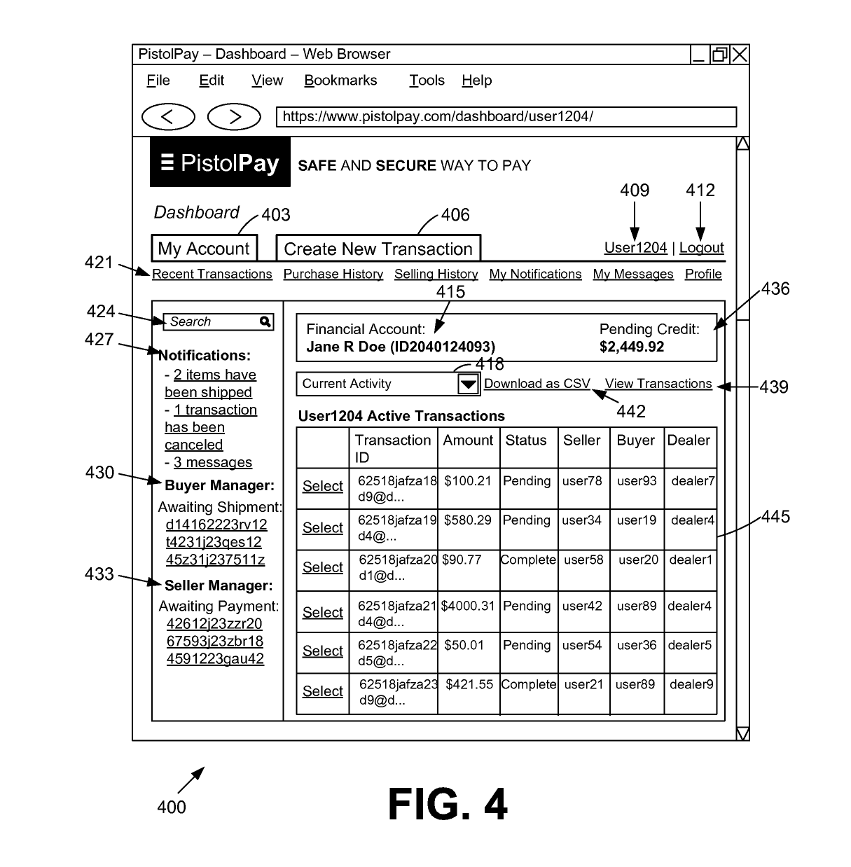

Moving on to FIG. 4, shown is a user interface 400 depicting a rendered network page 172 generated by the escrow intermediary application 163 that corresponds to a buyer/seller “dashboard” that displays various information and metrics corresponding to the respective buyer/seller account. In this example, the representative user interface 400 allows a user, who can be both a buyer and a seller, to view a variety of information associated with the user's respective account under tab 403. Tab 406 can permit a buyer/seller to create a new transaction while in the dashboard. Hyperlinks 409 and 412 show that the dashboard can be accessible after an authentication process. Hyperlinks 409 and 412 also show that the dashboard is associated with one user account. Hyperlink 412 permits the user to log out of the dashboard at any time. Hyperlinks 421 allow the buyer/seller to narrow the information displayed to, for example, recent transactions, purchase history, selling history, notifications, messages, profile information, etc. Search box 424 permits the buyer/seller to search for specific transactions, notifications, messages, links, or any other information. Lists 427, 430, and 433 display notifications that can be useful to buyer/seller such as notifying the buyer/seller which transaction items have been shipped and which particular transaction items are awaiting payment or shipment.

Text 415 displays information pertaining to a financial account associated with the user's account. A financial account can be, for example, a checking or savings account, a credit card, a trust account, or any other financial account. Text 436 shows the user's net balance associated with the user's account. Hyperlink 442 permits a user to export the information displayed in the dashboard, such as information displayed in table 445, to, for example, a comma-separated value document or other type of document. Hyperlinks 439 and 418 further permit the buyer/seller to tailor the information displayed by giving the buyer/seller the option of viewing all or certain types of transactions associated with the account.

Table 445 is an example of the type of information that can be relevant to the buyer/seller. The rows in table 445 can correspond to a particular transaction containing a unique transaction ID. Information associated with the currently viewed transactions can be populated in table 445, such as a unique transaction ID, the amount involved with the transaction, the status, the seller, the buyer, the dealer (if applicable), the date of the transaction, or any other information related to the transaction.

It is understood that the example user interface 400 is not intended to be limiting. In other embodiments, different parameters can be obtained from the buyer/seller and different parameters can be displayed in the dashboard. Additionally, in other embodiments, different user interface components from those in FIG. 4 can be used (e.g., checkboxes, sliders, text fields, text areas, links, buttons, radio buttons, dropdown menus, etc.). Although the example of FIG. 4 refers to multiple transactions, other interfaces can be provided to display information associated with a single transaction.

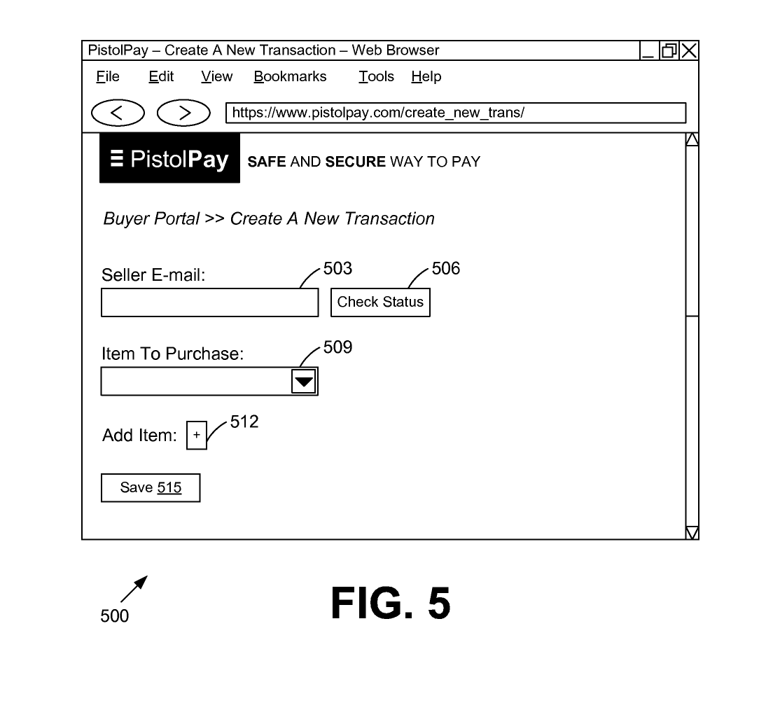

Turning now to FIG. 5, shown is a user interface 500 depicting a rendered network page 172 that corresponds to a page for a buyer to create a new transaction that has been generated by the escrow intermediary application 163. In this example, the representative user interface 500 prompts the user to identify a seller's e-mail address in textbox 503 that can be unique to a seller's account with the escrow intermediary application 163. A “check status” button 506 can be used to verify that an account has been registered and associated with the seller's e-mail address. Dropdown menu 509 can provide the items subject to the current transaction. Button 512 can be used to add items to dropdown menu 509. Button 515 can be used to save the current transaction and can take the buyer to a subsequent page. If a valid e-mail address is provided that is associated with a registered seller account, the seller can be notified of the transaction.

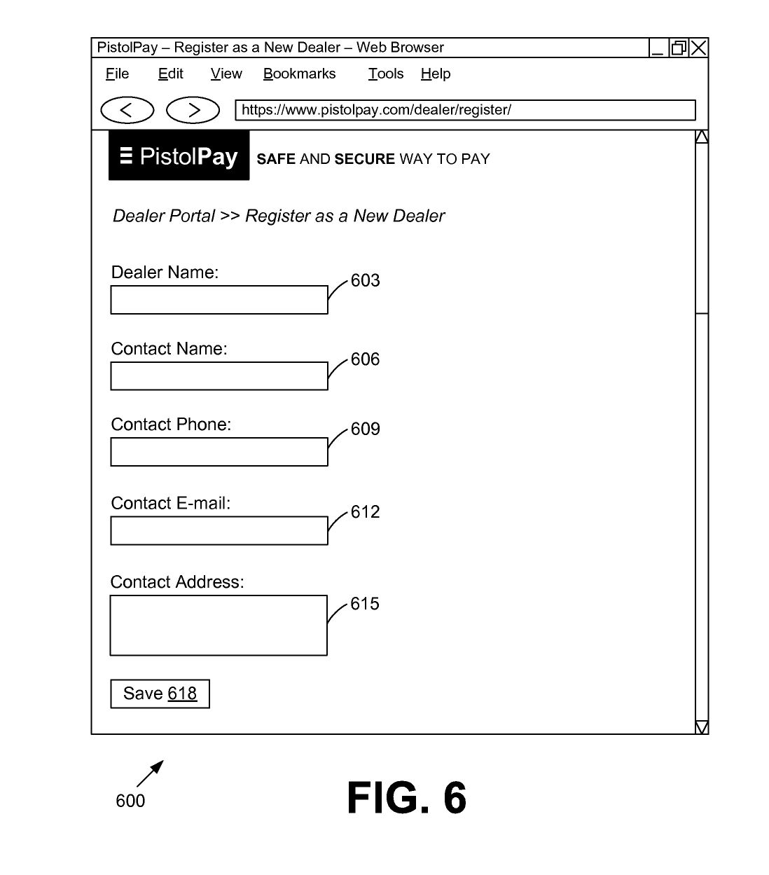

Turning now to FIG. 6, shown is a user interface 600 depicting a rendered network page 172 that corresponds to a page for a user to register as a dealer that has been generated by the escrow intermediary application 163. In this example, the representative user interface 500 prompts a user to identify information that can be useful and/or required to conduct a transaction as a dealer in the escrow intermediary application 163. Textboxes 603, 606, 609, 612, and 615 can be used to enter information about the dealer such as a dealer name or trade name, a contact name, a contact phone, a contact e-mail, a contact address, and any other information pertaining to the dealer. In another embodiment, more information can be requested from the user, such as licenses that the user can have obtained that can be necessary to participate in certain types of transactions as a third-party intermediary. For example, a transaction involving a firearm can require a third-party intermediary who is a federal firearm license (FFL) holder.

In one embodiment, the item being purchased in the electronic transaction can be limited to a particular industry, such as firearms, art, antiques, boats, real estate, motor vehicles, or any other industry. The requirements of the third-party intermediary will automatically be provided to the buyer and seller via the escrow intermediary application 163 and will be based at least in part on the item being purchased in the electronic transaction. Button 618 saves the information and can take the user to a subsequent page.

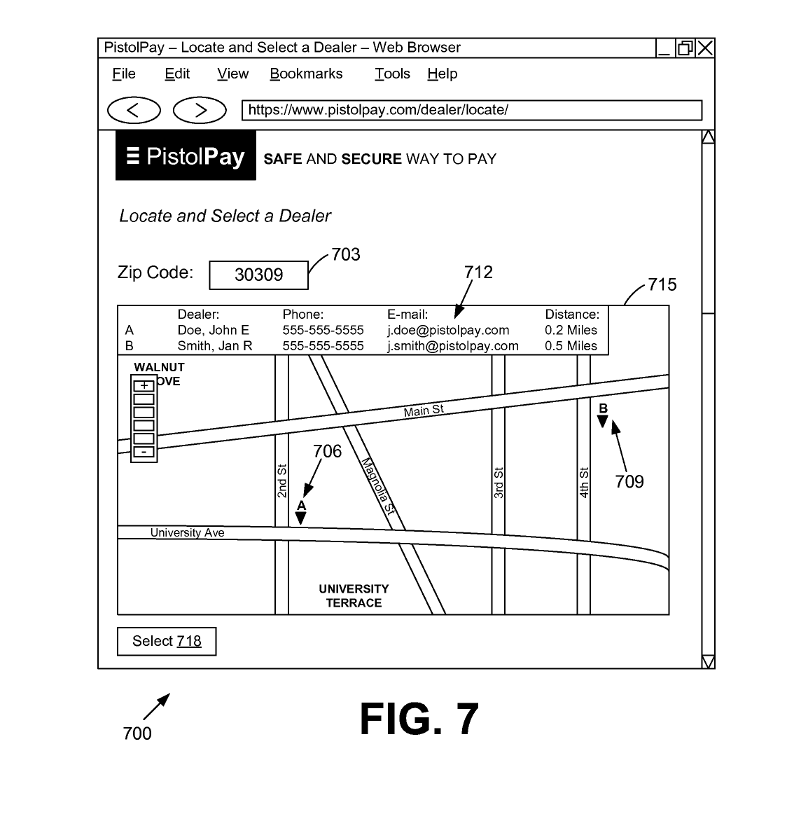

Moving on to FIG. 7, shown is a user interface 700 depicting a rendered network page 172 generated by the escrow intermediary application 163 that corresponds to a page for a buyer/seller to select a dealer. In this example, the representative user interface 700 prompts a buyer/seller to provide a zip code in textbox 703 in order to locate dealers located in that region. A map 715 is provided to the buyer/seller to facilitate in locating a dealer, especially when there are multiple dealers in a particular region. Items 706 and 709 identify precise locations of a dealer that can correspond to the information provided by the dealer during the dealer's registration with the escrow intermediary application 163. Items 706 and 708 also associate a dealer with a particular identifier, such as letters “A” and “B” that can be useful in associating a dealer with a particular row in table 712. Table 712 can provide the user with an organized display of multiple dealers in the region as well as the dealer's phone, e-mail, distance to the provided zip code, or any other information about the dealer. Button 718 permits the buyer/seller to finalize a dealer selection and can take the buyer/seller to a subsequent page.

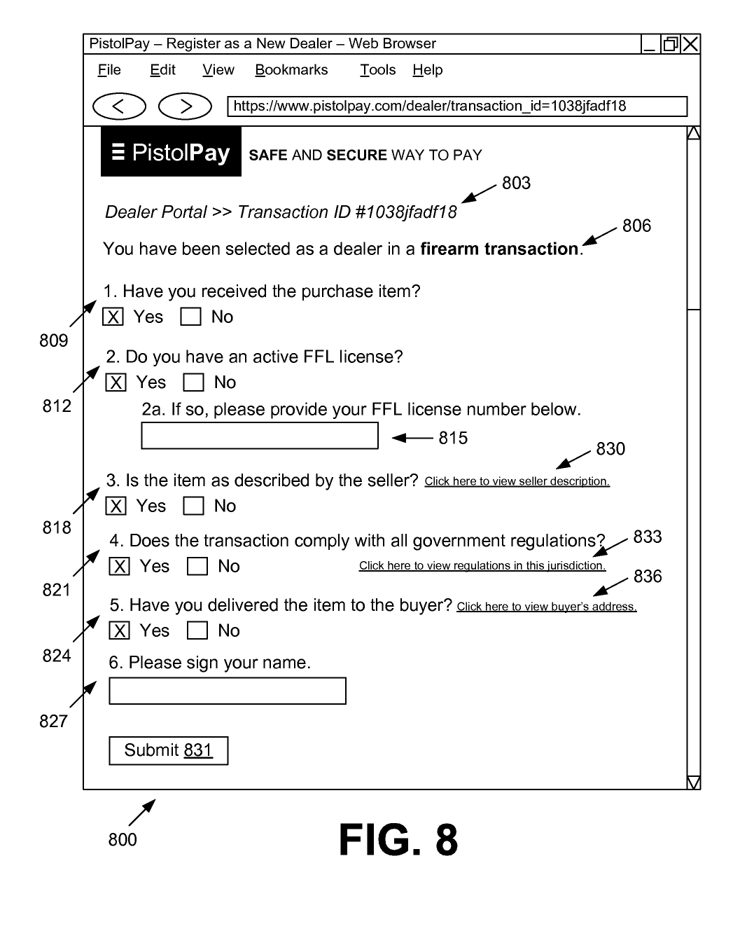

Moving on to FIG. 8, shown is a user interface 800 depicting a rendered network page 172 generated by the escrow intermediary application 163 that corresponds to a page for a dealer to act as a third-party intermediary in an electronic transaction. In this example, the representative user interface 800 prompts a dealer with an electronic form to be submitted prior to releasing escrow funds to the seller and/or third-party intermediary. Text 803 shows a unique identifier associated with an electronic transaction between a buyer and a seller. Text 806 identifies the type of transaction involved, for example, a transaction of a firearm. Field 809 prompts the dealer to verify receipt of the item. Field 812 prompts the dealer to verify a required license needed to act as a third-party intermediary. Field 815 prompts the dealer to provide a license number corresponding to, for example, an FFL license that can be required to act as a third-party intermediary in a firearm transaction.

Field 818, via escrow intermediary application 163, prompts the dealer to verify that the item is as was described by the seller. Hyperlink 830 can facilitate this by providing a hyperlink to a page generated by the escrow intermediary application 163 which displays the seller's description of the item. Next, field 821 prompts the dealer to verify that the transaction has complied with regulations. Hyperlink 833 can facilitate this by providing a hyperlink to a page generated by the escrow intermediary application 163 which displays the regulations in the applicable jurisdiction. Next, field 824 prompts the dealer to verify that the item has been delivered the buyer. Hyperlink 836 can facilitate this by providing a hyperlink to a page generated by the escrow intermediary application 163 which displays the buyer's address. Next, field 827 prompts the dealer to sign his or her name. Button 831 can save the data and/or take the dealer to a subsequent page.

After the dealer completes verification of the transaction, for example by submitting the form in user interface 800, the escrow intermediary application 163 will transfer the buyer's purchase money currently in escrow to the seller. A portion of the buyer's purchase money can also be transferred to the dealer as a commission for participating in the transaction. The dealer commission can be made available to the buyer and/or seller as a term prior to completion of the transaction. Alternatively, the dealer's commission can be automatically calculated by the escrow intermediary application 163. The commission can be based on the type of transaction involved, the required amount of participation of the dealer, or the amount of the purchase price of the transaction.

The transfer of the purchase money in escrow to the seller and/or to the dealer can be conducted through a third-party financial service, a wire transfer, direct deposit, or any other method of electronic payment. It is understood that the fields 809-827 are intended to be a non-limiting example.

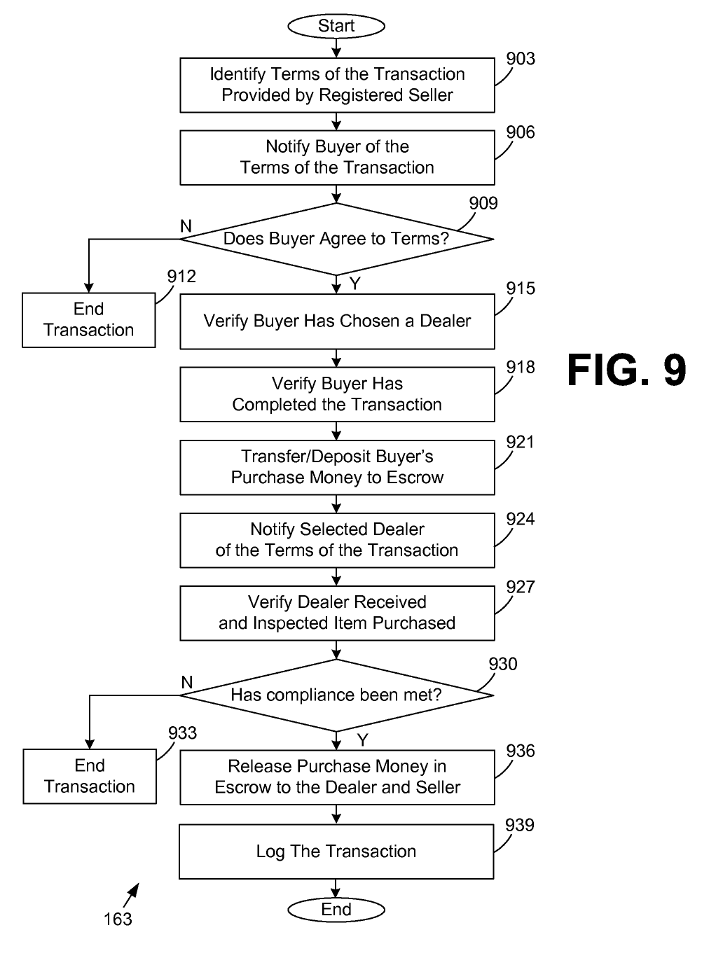

Referring next to FIG. 9, shown is a flowchart that provides one example of the operation of a portion of the escrow intermediary application 163 according to various embodiments. It is understood that the flowchart of FIG. 9 provides merely an example of the many different types of functional arrangements that can be employed to implement the operation of the portion of the escrow intermediary application 163 as described herein. As an alternative, the flowchart of FIG. 9 can be viewed as depicting an example of steps of a method implemented in the computing device 103 (FIG. 1) according to one or more embodiments.

To begin, it is assumed that an electronic transaction is being conducted in an electronic commerce application 120 in which a buyer is purchasing an item from a seller. For example, a buyer may be purchasing a firearm via an electronic commerce application 120 from a seller, the electronic commerce application 120 owned and/or operated by a third-party entity. To conduct a financial portion of the electronic transaction (e.g., the financial transaction), the electronic commerce application 120 may communicate with the escrow intermediary application 163. To this end, the electronic commerce application 120 may direct a user of the electronic commerce application 120 (e.g., the buyer) to a portal of user interfaces generated by the escow intermediary application 163 in order to obtain the necessary information from the buyer and/or seller to complete the financial transaction. Alternatively, the electronic commerce application 120 may communicate with the escrow intermediary application 163 via one or more programmatic service calls (e.g., API calls). For example, the electronic commerce application 120 may send one or more requests to the escrow intermediary application 163 to conduct the financial transaction. The one or more requests may comprise information associated with the electronic transaction being conducted, such as: a buyer's name, a buyer's address, a purchase amount, an item being purchased in the electronic transaction, a type of the item being purchased in the electronic transaction, a seller's name, a seller's address, financial data, the terms of the transaction (provided by a buyer and/or seller), and/or any other information associated with the electronic transaction.

In box 903, the escrow intermediary application 163 identifies one or more terms of the electronic transaction, if provided by a seller and/or a buyer. A term of the transaction may be criteria provided by the seller and/or buyer that must be satisfied prior to a completion of a transaction and/or a release of funds from the buyer to the seller. To this end, one or more terms of a transaction may be communicated from an electronic commerce system 120 (FIG. 1) to the escrow intermediary application 163 for use in determining compliance of the one or more terms associated with the transaction. The terms of the transaction can be automatically provided by a third-party electronic commerce application 120 after clicking, for example, a button 209 (FIG. 2). Alternatively, the terms of the transaction can be manually provided by the seller using the “Create New Transaction” tab 406 (FIG. 4).

In box 906, the buyer is notified of the one or more terms of the transaction defined by the seller, if the buyer has yet to be notified of the one or more terms. In box 909, the escrow intermediary application 163 determines whether the buyer has agreed to the terms. If the buyer does not agree to the terms of the transaction, the attempted transaction is ended in box 912, and notifications indicating that the buyer has declined the terms of the transaction may be communicated to the seller. According to various embodiments, additional user interfaces may be rendered by the escrow intermediary application 163 that may assist with and/or facilitate a buyer in countering the seller's terms with his or her own terms. If the buyer agrees to the terms of the transaction, the buyer is prompted to choose a dealer in box 915. For example, a buyer can be prompted to choose a dealer via user interface 700 (FIG. 7). In alternative embodiments, the escrow intermediary application 163 may automatically determine a dealer using a buyer's location, a seller's location, a dealer location, a proximity of these locations, and/or any combination thereof. The selection of a dealer may be further based at least in part on whether the dealer has a license corresponding to a type of the item being purchased. For example, in the event a transaction involves a sale of a firearm, dealers having an FFL license may be presented to the buyer, seller, and/or automatically identified by the escrow intermediary application 163 to act as the dealer for the transaction.

In box 918, the buyer can be prompted to complete the transaction by providing a method of payment and verifying the same. The payment can be made by a buyer in the form of a credit card, mail order, check, wire transfer, deposit, or by any other method. In box 921, the escrow intermediary application 163 transfers or deposits the purchase money provided by the buyer in an escrow account. The escrow account may be an account managed by a company operating the escrow intermediary application 163. Alternatively, the escrow account may be an account managed by an independent third-party escrow service. The dealer selected by the buyer in box 915 (or automatically identified by the escrow intermediary application 163) is notified the terms of the transaction in box 924. Although the dealer may be familiar with laws and/or regulations associated with particular transactions in various jurisdictions, the escrow intermediary application 163 may automatically identify applicable laws and/or regulations and communicate the one or more regulations to the dealer.

In box 927, receipt and conformity of the item is verified by the buyer, an agent with a duty to inspect the goods delegated by the buyer, and/or the dealer acting as a third-party intermediary. According to various embodiments, a buyer may provide whether the item has been received by the buyer or his or her agent and is as described by the seller via one or more user interfaces generated by the escrow intermediary application 163.

In box 930, it is determined whether compliance with regulations has been met. For example, the escrow intermediary application 163 can determine whether data required to determine whether the transaction has complied with the one or more terms and/or one or more regulations associated with the transaction was provided by the dealer via user interface 800. If not, in box 933, the transaction may be ended. In box 936, all or at least a portion of the purchase money in escrow is released to the dealer and the seller according to the terms of the transaction. As can be appreciated, all or a portion of the purchase money held in escrow may not be released unless the one or more terms of the transaction (if applicable) and/or one or more regulations have been met. Release of the purchase money may be initiated by the buyer, the dealer, an administrator of the escrow intermediary application 163, or automatically by the escrow intermediary application 163. Finally, in box 939, the transaction is logged, for example, in an electronic database. The log may be encrypted according to one or more encryption schemes and/or hash methodologies.

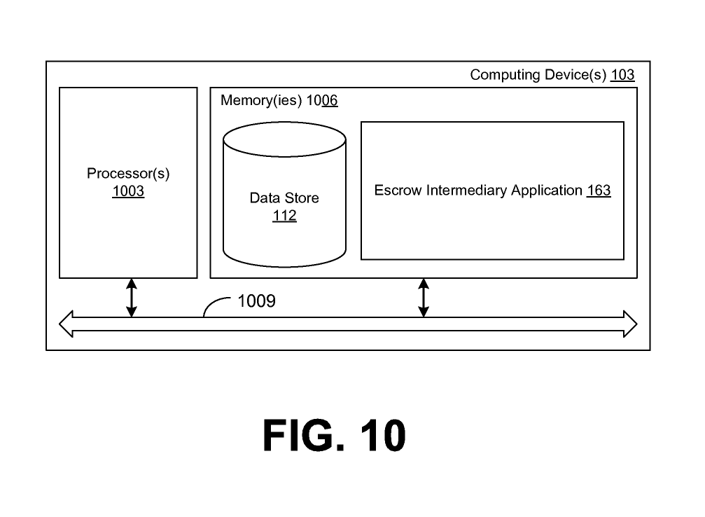

With reference to FIG. 10, shown is a schematic block diagram of the computing device 103 according to an embodiment of the present disclosure. The computing device 103 includes at least one processor circuit, for example, having a processor 1003 and a memory 1006, both of which are coupled to a local interface 1009. To this end, the computing device 103 can comprise, for example, at least one server computer or like device. The local interface 1009 can comprise, for example, a data bus with an accompanying address/control bus or other bus structure as can be appreciated.

Stored in the memory 1006 are both data and several components that are executable by the processor 1003. In particular, stored in the memory 1006 and executable by the processor 1003 are an escrow intermediary application 163, and potentially other applications. Also stored in the memory 1006 can be a data store 112 and other data. In addition, an operating system can be stored in the memory 1006 and executable by the processor 1003.

It is understood that there can be other applications that are stored in the memory 1006 and are executable by the processors 1003 as can be appreciated. Where any component discussed herein is implemented in the form of software, any one of a number of programming languages can be employed such as, for example, C, C++, C#, Objective C, Java, Javascript, Perl, PHP, Visual Basic, Python, Ruby, Delphi, Flash, or other programming languages.

A number of software components are stored in the memory 1006 and are executable by the processor 1003. In this respect, the term “executable” means a program file that is in a form that can ultimately be run by the processor 1003. Examples of executable programs can be, for example, a compiled program that can be translated into machine code in a format that can be loaded into a random access portion of the memory 1006 and run by the processor 1003, source code that can be expressed in proper format such as object code that is capable of being loaded into a random access portion of the memory 1006 and executed by the processor 1003, or source code that can be interpreted by another executable program to generate instructions in a random access portion of the memory 1006 to be executed by the processor 1003, etc. An executable program can be stored in any portion or component of the memory 1006 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1006 is defined herein as including both volatile and nonvolatile memory and data storage components. Volatile components are those that do not retain data values upon loss of power. Nonvolatile components are those that retain data upon a loss of power. Thus, the memory 1006 can comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM can comprise, for example, static random access memory (SRAM), dynamic random access memory (DRAM), or magnetic random access memory (MRAM) and other such devices. The ROM can comprise, for example, a programmable read-only memory (PROM), an erasable programmable read-only memory (EPROM), an electrically erasable programmable read-only memory (EEPROM), or other like memory device.

Also, the processor 1003 can represent multiple processors 1003 and the memory 1006 can represent multiple memories 1006 that operate in parallel processing circuits, respectively. In such a case, the local interface 1009 can be an appropriate network 109 (FIG. 1) that facilitates communication between any two of the multiple processors 1003, between any processor 1003 and any of the memories 1006, or between any two of the memories 1006, etc. The local interface 1009 can comprise additional systems designed to coordinate this communication, including, for example, performing load balancing. The processor 1003 can be of electrical or of some other available construction.

Although the electronic commerce application 120 (FIG. 1), the escrow intermediary application 163 (FIG. 1), and other various systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 9 shows the functionality and operation of an implementation of portions of the escrow intermediary application 163 (FIG. 1). If embodied in software, each block can represent a module, segment, or portion of code that comprises program instructions to implement the specified logical function(s). The program instructions can be embodied in the form of source code that comprises human-readable statements written in a programming language or machine code that comprises numerical instructions recognizable by a suitable execution system such as a processor 1003 in a computer system or other system. The machine code can be converted from the source code, etc. If embodied in hardware, each block can represent a circuit or a number of interconnected circuits to implement the specified logical function(s).

Although the flowchart of FIG. 9 shows a specific order of execution, it is understood that the order of execution can differ from that which is depicted. For example, the order of execution of two or more blocks can be scrambled relative to the order shown. Also, two or more blocks shown in succession in FIG. 9 can be executed concurrently or with partial concurrence. Further, in some embodiments, one or more of the blocks shown in FIG. 9 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the electronic commerce application 120 (FIG. 1) and the escrow intermediary application 163 (FIG. 1), that comprises software or code can be embodied in any non-transitory computer-readable medium for use by or in connection with an instruction execution system such as, for example, a processor 1003 in a computer system or other system. In this sense, the logic can comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including, for example, static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying a program executable in at least one computing device, comprising:
code that receives a request from a third-party application to conduct a financial transaction via an escrow intermediary application, the financial transaction corresponding to an electronic transaction conducted in the third-party application, the request comprising at least a type of at least one of a plurality of items being purchased in the electronic transaction;
code that determines whether a buyer and a seller of an item in the electronic transaction conducted in the third-party application are registered in an electronic database;
if the buyer and the seller are registered in the electronic database, the program further comprising:
code that determines a plurality of terms of the financial transaction based at least in part on the type of the at least one of the plurality of items being purchased in the electronic transaction;
code that communicates the terms of the financial transaction to the third-party intermediary;
code that transfers at least a percentage of purchase money to an escrow account associated with the financial transaction, the escrow account independent of the escrow intermediary application;
code that facilitates a verification of delivery of the purchase item and conformance of the purchase item associated with the financial transaction;
code that facilitates a release of the purchase money in the escrow account to the seller by the third-party intermediary minus a transaction fee;
code that generates an encrypted log comprising information associated with the financial transaction to be stored in memory; and
code that communicates the information associated with the financial transaction to the third-party application.

2. The non-transitory computer-readable medium of claim 1, further comprising code that transfers at least a percentage of the purchase money in the escrow account to an account associated with the third-party intermediary.

3. The non-transitory computer-readable medium of claim 1, further comprising code that determines a regulation and associates the regulation with the electronic transaction.

4. The non-transitory computer-readable medium of claim 3, wherein a transfer of the purchase money is contingent on compliance of the regulation associated with the electronic transaction.

5. A system, comprising:
at least one computing device; and
an escrow intermediary application executable in the at least one computing device, the escrow intermediary application comprising:
logic that receives a request from a third-party application to conduct a financial transaction via an escrow intermediary application, the financial transaction corresponding to an electronic transaction conducted in the third-party application, the request comprising at least a type of at least one of a plurality of items being purchased in the electronic transaction;
logic that determines a plurality of terms of the financial transaction based at least in part on the type of the at least one of the plurality of items being purchased in the electronic transaction;
logic that communicates the terms of the financial transaction to the third-party intermediary;
logic that transfers at least a percentage of purchase money to an escrow account associated with the financial transaction, the escrow account independent of the escrow intermediary application;
logic that facilitates a verification of delivery of the purchase item and conformance of the purchase item associated with the financial transaction; and
logic that facilitates a release of the purchase money in the escrow account to a seller by the third-party intermediary.

6. The system of claim 5, wherein the third-party intermediary is selected based at least in part on a proximity of a location to a buyer.

7. The system of claim 5, the escrow intermediary application further comprising logic that communicates information associated with the financial transaction to the third-party application.

8. The system of claim 5, the escrow intermediary application further comprising the logic that transmits the term of the financial transaction to the third-party intermediary.

9. The system of claim 5, the escrow intermediary application further comprising logic that determines a regulation and associates the regulation with the electronic transaction.

10. The system of claim 8, wherein a transfer of the purchase money is contingent on compliance of a regulation associated with the electronic transaction.

11. The system of claim 5, the escrow intermediary application further comprising logic that verifies compliance of a regulation associated with the electronic transaction through a generated third-party intermediary user interface.

12. The system of claim 5, further comprising logic that transfers at least a percentage of a buyer's purchase money in the escrow account to an account associated with the third-party intermediary.

13. A computer-implemented method, comprising:
receiving, by a computing device, a request from a third-party application to conduct a financial transaction via an escrow intermediary application, the financial transaction corresponding to an electronic transaction conducted in the third-party application, the request comprising at least a type of at least one of a plurality of items being purchased in the electronic transaction;
determining, by the computing device, a plurality of terms of the financial transaction based at least in part on the type of the at least one of the plurality of items being purchased in the electronic transaction;
communicating, by the computing device, the terms of the financial transaction to the third-party intermediary;
transferring, by the computing device, at least a percentage of purchase money to an escrow account associated with the financial transaction, the escrow account independent of the escrow intermediary application;
facilitating, by the computing device, a verification of delivery of the purchase item and conformance of the purchase item associated with the financial transaction; and
facilitating, by the computing device, a release of the purchase money in the escrow account to a seller by the third-party intermediary.

14. The computer-implemented method of claim 13, further comprising associating, by the computing device, a buyer, the seller, and the third-party intermediary with an electronic profile in an electronic database.

15. The computer-implemented method of claim 14, wherein the third-party intermediary is selected based at least in part on a proximity of a location to the buyer.

16. The computer-implemented method of claim 13, further comprising the step of determining a regulation and associating the regulation with the electronic transaction.

17. The computer-implemented method of claim 13, further comprising the step of transmitting the terms of the electronic transaction to the third-party intermediary.

18. The computer-implemented method of claim 13, further comprising the step of verifying compliance of a regulation associated with the electronic transaction through a generated third-party intermediary user interface.

19. The computer-implemented method of claim 18, wherein a transfer of the purchase money is contingent on compliance of the regulation associated with the electronic transaction.

20. The computer-implemented method of claim 13, further comprising the step of transferring the at least a percentage of the purchase money in the escrow account to an account associated with the third-party intermediary.
